(19) United States
(12) Patent Application Publication
(10) Pub. No.: US 2026/0158907 A1
(43) Pub. Date: Jun. 11, 2026

(54) DISPLAY SYSTEM

(71) Applicant: AUDI AG, Ingolstadt (DE)

(72) Inventors: Lars ELLERMANN, Ingolstadt (DE); Steffen ROSS, Wettstetten (DE)

(21) Appl. No.: 19/415,659

(22) Filed: Dec. 10, 2025

(30) Foreign Application Priority Data
Dec. 11, 2024 (DE) 102024137174.9

(51) Int. Cl. B60K 35/21; B60K 35/215; B60K 35/22

(52) U.S. Cl. CPC B60K 35/211; B60K 35/215; B60K 35/22; B60K 2360/23; B60K 2360/332

(57) ABSTRACT

A display system for a vehicle is provided which includes a display panel with four outer edges and at least two mirror modules, wherein a respective reflection space is arranged on each of at least two mutually parallel outer edges of the display panel, wherein front sides as front base sides of the two parallel reflection spaces are covered by at least one front mirror module, and rear sides as rear base sides of the two parallel reflection spaces are covered by at least one rear mirror module, wherein an inner side of each reflection space is delimited by a wall designed as an outer edge of the display panel, wherein an outer side of each reflection space is delimited by a further wall, wherein light sources are arranged on at least one of the two walls of each reflection space , wherein the light sources are designed to emit light into the respective reflection space , wherein the two mirror modules are designed to reflect the light in the respective reflection space, wherein reflections of the light are visible through the at least one mirror module arranged on the front sides and are designed to create an optical depth effect for the display panel.

### BACKGROUND

### Technical Field

The disclosure relates to a display system for a vehicle, and a method for operating a display system for a vehicle.

### Description of the Related Art

A device for preventing kinetosis of at least one occupant in a vehicle is known from publication DE102020216295A1.

A display device for a motor vehicle for the virtual representation of optical image information is described in publication DE102018211747A1.

### BRIEF SUMMARY

Against this background, embodiments of the disclosure appropriately present the content of a display to a vehicle occupant.

The display system according to the disclosure is designed for a vehicle, e.g., a motor vehicle, and has a rectangular display panel or display with four outer edges and at least two mirror modules. In this case, a reflection space of a frame for the display panel is arranged on each of at least two mutually parallel outer edges of the display panel, with the display panel being arranged between the two parallel reflection spaces.

The display panel has a front side as front base side and a rear side as rear base side, with a display surface for displaying a respective display content being integrated into the front side of the display panel. In the presented embodiment of the display system, each of the at least two mutually parallel reflection spaces has a front side or front base side, and a rear side as a rear base side. All front sides face, and are visible to, an observer as a vehicle occupant, whereas all rear sides are concealed.

Furthermore, each reflection space, which is usually cuboid-shaped, has an inner side and an outer side, with the inner side facing an outer edge of the display panel and the outer side facing away from it. In this case, the inner side of each reflection space is at least partially delimited by a wall designed as an outer edge of the display panel, with an outer side of each reflection space being delimited by a further wall.

In the display system, front sides of the parallel reflection spaces are covered and/or delimited by at least one front mirror module, and rear sides of the parallel reflection spaces are covered and/or delimited by at least one rear mirror module. Light sources are arranged on at least one of the two walls on the inner side and/or outer side of each reflection space, the light sources for each reflection space are arranged along at least one line in a band and/or strip and are designed to emit light into the respective reflection space, and the two mirror modules are designed to mutually and/or alternately reflect the light in the respective reflection space, providing an infinity mirror and/or pinhole mirror effect, i.e., to reflect the light back and forth in the reflection space between the mirror modules. The resulting reflections of the light in this case are visible through the at least one mirror module arranged on the front sides and are designed to create an optical depth effect for the display panel and its observer between the reflection spaces.

In this case, starting from each reflection space as part of the frame for the display panel, the observer can see reflections of the light elements or light sources that optically form a, for example, continuous line, wherein this line runs parallel to a respective outer edge of the display panel on which the respective reflection space is arranged. In this case, a width of a respective line, which is displayed to the observer by a respective mirror module on the front side of the respective reflection space, is greater or thicker the further this line is from the outer edge of the display panel, and the width is smaller or thinner the closer it is to the outer edge. The light elements parallel to, or surrounding, the outer edge along the line and/or the strip can be controlled and/or regulated separately, and optionally varied in terms of their color and/or brightness, wherein both the brightness and the color can also be changed.

Typically, a horizontally oriented reflection space is arranged on both horizontal outer edges of the display panel, or possibly only on the two horizontal outer edges of the display panel. Alternatively or additionally, a vertically oriented reflection space is arranged on both vertical outer edges of the display panel, or possibly only on the two vertical outer edges of the display panel.

If, in the display system, four reflection spaces are arranged on all four outer edges of the display panel, i.e., two vertically and two horizontally oriented reflection spaces in each case, the at least one mirror module, which covers the front sides of all reflection spaces, displays a plurality of nested rectangles formed from the light elements arranged along the lines and their reflections, which optically form a plurality of frames, with each side of four sides of each rectangular frame being formed in each case from one line of light elements emitted from a respective reflection space in each case. In this case, the largest frame has the thickest lines, and the smallest frame has the thinnest lines.

The at least one front mirror module, which covers the front side of a respective reflection space, is designed and/or designated as a partial mirror that only partially reflects light propagating by reflection between the two mirror modules, e.g., a first fraction of x%, back into the reflection space, and transmits or lets it pass outward a second fraction of 100% - x%, thereby displaying the individual lines. This mirror module is partially reflective and partially transparent, e.g., semi-reflective and semi-transparent, if x = 50.

The respective front mirror module consists of a transparent pane of glass or plastic, e.g., Plexiglas, wherein a side of the mirror module, which faces the reflection space, has a layer and/or film that is only partially reflective according to a fraction of x%, and/or is provided, e.g., coated, therewith. The at least one rear mirror module, which covers the rear side of a respective reflection space, is designed and/or designated as a full mirror, which fully reflects light propagating by reflection between the two mirror modules into the reflection space. Each front mirror module can be designed and/or designated as a partially transparent, e.g., semi-transparent, and partially reflective, e.g., semi-reflective, front cover, or as a fully reflective rear cover or cover surface of the respective reflection space.

In addition, at least one base side, i.e., the front side and/or the rear side, of the at least two mutually parallel reflection spaces, usually all reflection spaces, is covered by its own mirror module in each case. In the case of four reflection spaces, it is provided that the total of four mirror modules for the respective front and/or rear base sides are continuous and/or interconnected and form a continuous and/or one-piece frame-shaped mirror module that covers the front sides and/or the rear sides of all reflection spaces. In this case, the mirror modules can form a one-piece frame-shaped cover that is recessed in the area of the front side or the rear side of the display panel. Alternatively, the mirror modules and a transparent window for the display panel in the area of the front of the display panel can form a continuous rectangular cover, with the partially transparent or partially reflective mirror modules enclosing and/or framing the window located between them.

It is also possible that the rear sides of all reflection spaces and also the rear side of the display panel enclosed by them are covered by a common rectangular one-piece mirror module.

In some configurations, the display system has at least one servo motor which is designed to pivot and/or rotate the at least one rear mirror module vertically and/or horizontally relative to the display surface on the front side of the display panel depending on a rotation and/or direction of rotation as a movement of the vehicle about at least one spatial axis, which is detected by at least one sensor of the display system and/or the vehicle in a respective driving situation, i.e., a separate rear mirror module for covering a respective rear side of a reflection space or a single rear mirror module for covering the rear sides of all reflection spaces and the display panel in each case. In this case, the at least one servo motor is designed, depending on a signal provided to it by the at least one sensor and relating to the currently detected movement, to rotate the at least one rear mirror module with respect to the at least one vertical axis in the direction of rotation opposite to the sensor-detected direction of rotation of the vehicle, wherein the movement, i.e., at least the rotation, of the vehicle is optically compensated by an opposite movement, e.g., rotation, of the at least one rear mirror module. In some configurations, the at least one rear mirror module is rigid and arranged parallel to the display surface of the display panel. Furthermore, the at least one front mirror module is rigid and arranged parallel to a display surface of the display panel. Alternatively or additionally, it is also possible for the at least one rear mirror module to be rotated with respect to the at least one vertical axis in the same direction of rotation as the sensor-detected direction of rotation of the vehicle.

The light sources, which are designed as light-emitting diodes, for example, are arranged on and/or in the wall, which covers and/or delimits the inner side of a respective reflection space, or on and/or in the wall, which covers and/or delimits the outer side of a respective reflection space. The wall for the inner side in this case can also be designed as the outer edge of the display module. In a configuration, the display system can have a housing and/or be arranged in a component of the vehicle, wherein the housing and/or component has a recess in which the display panel and the reflection spaces are arranged. In this case, an inner wall of the recess can also be designed as a wall, which covers and/or delimits the outer side of a respective reflection space.

The method according to the disclosure is designed for operating a display system, for example an embodiment of the display system presented above, for a vehicle. The display system has a rectangular display panel with four outer edges and at least two mirror modules, wherein a reflection space of a frame is arranged on at least two mutually parallel outer edges of the display panel in each case, wherein, in each case, parallel reflection spaces enclose the display panel located between them. In this case, front sides, as front base sides of the two parallel reflection spaces, are covered and/or delimited by at least one front mirror module, and rear sides, as rear base sides of the two parallel reflection spaces, are covered and/or delimited by at least one rear mirror module. In this case, an inner side of each reflection space is at least partially delimited by a wall designed as the outer edge of the display panel, and an outer side of each reflection space is delimited by a further wall. The light sources are arranged on at least one of the two walls of each reflection space, light is emitted from the light sources into the respective reflection space, the light is mutually and/or alternately reflected by the two mirror modules in the respective reflection space, providing an infinity mirror and/or pinhole mirror effect, and reflections of the light are or become visible through the at least one mirror module arranged on the front sides and create an optical depth effect for the display panel between the reflection spaces.

The method is carried out for a display system of a vehicle and/or in a vehicle for which a typically vertically oriented vertical axis, a transverse axis, and a longitudinal axis, both typically horizontally oriented, will be and/or are defined as spatial axes. A rotation and/or direction of rotation is detected as a movement of the vehicle about the at least one spatial axis by at least one sensor of the display system and/or the vehicle, which is designed to detect this movement. The vehicle rotates to the left or right about its vertical axis when cornering.

Furthermore, the at least one rear mirror module is rotated opposite to the direction of rotation of the sensor-detected rotation of the vehicle relative to a display surface of the display panel. During travel, the vehicle is rotated about a spatial axis that runs parallel to two reflection spaces, wherein the at least one rear mirror module for each of these two reflection spaces is rotated opposite to the direction of rotation of the sensor-detected rotation of the vehicle relative to a display surface of the display panel. Furthermore, it is possible for the light sources of a first of the two reflection spaces to emit a first color into the respective reflection space, and for the light sources of a second of the two reflection spaces to emit a second color into the respective reflection space.

In some configurations, the at least one sensor determines, as an angle, a roll angle during a rotation about a roll axis of the vehicle that corresponds to its longitudinal axis, a pitch angle during a rotation about a pitch axis of the vehicle that corresponds to its transverse axis, and/or a yaw angle during a rotation about a roll axis of the vehicle that corresponds to its vertical axis, and the at least one rear mirror module is rotated opposite to the respectively detected angle.

It is possible that the vehicle, for example due to a steering maneuver, is moved, for example, controlled or steered, and/or drives, sideways to the left or to the right, wherein the vehicle is rotated counterclockwise to the left when moving to the left about the vertical axis, or clockwise to the right when moving in the opposite direction to the right. A respective lateral movement, for example rotation, of the vehicle in a respective lateral direction or according to the respective direction of rotation is detected by sensors and the at least one rear mirror module is rotated relative to the display surface opposite to the lateral movement, for example rotation.

The reflection spaces can be used to provide a light frame for the vehicle’s display panel to combat motion sickness by rotating the pinhole mirror effect created thereby opposite to a sensor-determined direction of rotation. In this method, motion sickness of an observer of the framed display panel is reduced by adjusting the pinhole mirror effect created by the reflection spaces, usually in dependence on the direction of rotation, if the observer visually perceives the movement of the vehicle peripherally. The frame formed from the reflection spaces, e.g., a light frame, for the display panel enclosed by it can also be used to create a depth effect that contributes to immersive perception. In this case, the pinhole mirror effect and/or infinity mirror effect create(s) a fully comprehensive perception for the observer and thus effectively reduces motion sickness.

In addition, the display content presented by the display panel, which is known and/or determined, is also taken into account, wherein, in some configurations, the mirror pinhole mirror effect and/or a respective direction of rotation of the at least one mirror module is reacted to. Thus, interpretation in cases of moving and/or dynamic images, such as, for example, films, as display content is different than for static images as display content, which are read, for example. For both static and dynamic display content, e.g., an image or multiple images, the reflection space with the light sources (LEDs) is adapted with regard to a color and brightness to be set to a color and brightness of an outer area and/or edge of the display content. If the movement of the vehicle changes, the reflection space can be illuminated more brightly when the vehicle is accelerated, or darkened when it is accelerated inversely or decelerated. Accordingly, lighting of the reflection space can be adapted to a change in the movements of a dynamic display content, e.g., a film, thereby increasing immersion.

For reducing motion sickness, driving dynamics of the vehicle are visually displayed with and/or by the display system, wherein the at least one mirror module is rotated against a respective sensor-determined direction, e.g., direction of rotation, and/or optionally in the respective sensor-determined direction, e.g., direction of rotation. In the case of two parallel, vertically or horizontally oriented reflection spaces, the spatial axis to be considered can run parallel between the reflection spaces. In this case, the one of the two reflection spaces that lies on the side of the spatial axis between them, from which the vehicle is moved away when rotating about the respective spatial axis, is optically highlighted compared to the other reflection space arranged parallel to it. The other reflection space, in contrast, is optically reduced. In some configurations, the brightness of the light sources in the reflection space to be optically highlighted is increased, whereas the brightness of the light sources in the other reflection space is reduced. In this case, the depth effect is enhanced for the one of the two reflection spaces whose light sources are set brighter than the light sources of the other.

For negotiating a right-hand curve, light from the designated light sources is set to be stronger, more intense and/or brighter for a reflection area located to the left of the display panel, whereas light from the light sources for a reflection area arranged to the right of the display field is attenuated. In contrast, for negotiating a left-hand curve, light from the designated light sources is set to be stronger, more intense and/or brighter for a reflection area located to the right of the display panel, whereas light from the light sources for a reflection area arranged to the left of the display field is attenuated.

The pinhole mirror effect to be displayed can also be enhanced by selecting the colors of the light sources. In this case, for the one of the two parallel reflection spaces that is to be optically highlighted, a bright and/or vivid color, such as red or light green, is set, whereas, for the other reflection space, a comparatively subdued and/or dark color, such as dark blue or gray, is set.

The same is also possible during a usually positive acceleration of the vehicle, wherein it is rotated clockwise about its transverse axis, or during braking, which is negative acceleration, wherein it is rotated clockwise about its transverse axis. During acceleration, when the vehicle is rotated upwards by a pitch angle, opposite to the direction of rotation, the lower of the two horizontally arranged reflection spaces is optically highlighted and the upper one is optically reduced. In contrast, during braking, when the vehicle is rotated downwards by a pitch angle, opposite to the direction of rotation, the upper of the two horizontally arranged reflection spaces is optically highlighted and the lower one is optically reduced.

It is possible to combine the optical highlights of the reflection spaces, i.e., the horizontal reflection spaces when accelerating or braking and/or the vertical reflection spaces when negotiating a curve.

Furthermore, the display system can be used to provide an entertainment function. Here, the display content to be displayed can be enhanced by adapting the color and/or brightness of the light sources designed as LEDs, for example, on the display panel. In this case, the colors of images to be displayed and/or a distribution of colors on a particular image can be optically enhanced by setting the colors in the reflection spaces, and the display area of the display panel can be optically extended to include the frame made up of the reflection spaces. For example, if a film is being watched in which a scene shows a beach with a sea, the light sources of the upper reflection space are set to blue and the light sources of the lower reflection space are set to yellow. To optically highlight music, flashing of the light sources can be adapted to the beat of the music. A function and/or mode for colored and/or asymmetrical lighting of the reflection spaces can be activated by a vehicle occupant or automatically. Modes that can be set are “Anti-Motion Sickness”, “Film Support”, “Music Frame” and/or “Ambient” mode, for example when the display system is networked with ambient lighting.

It should be understood that the features mentioned above and those to be explained below can be used not only in the combination specified in each case, but also in other combinations or on their own, without departing from the scope of the present disclosure.

### BRIEF DESCRIPTION OF THE SEVERAL VIEWS OF THE DRAWINGS

The disclosure is illustrated schematically in the drawing based on embodiments and is described schematically and in detail with reference to the drawing.

FIG. 1 shows a schematic representation of a first embodiment of the display system according to the disclosure for carrying out a first embodiment of the method according to the disclosure.

FIG. 2 shows a schematic representation of a second embodiment of the display system according to the disclosure for carrying out a second embodiment of the method according to the disclosure.

### DETAILED DESCRIPTION

The figures are described coherently and comprehensively. Like reference numerals designate like components.

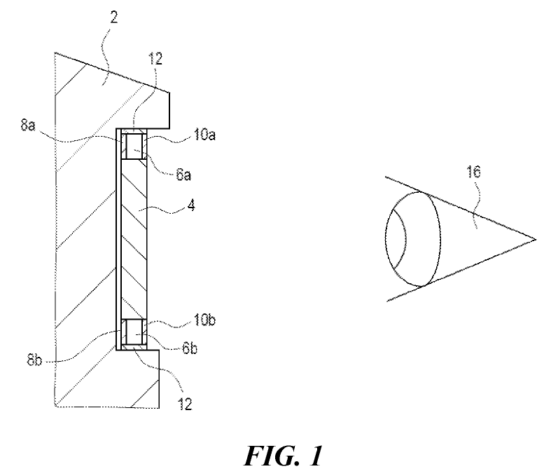

A first embodiment of the display system according to the disclosure, shown schematically in sectional view in FIG. 1, for a vehicle designed here as a motor vehicle, is arranged in a recess in a component 2, here a cockpit structure, in an interior of the vehicle.

The display system has a central display panel 4, which is framed and/or bordered here by four reflection spaces 6a, 6b, with only one upper horizontally arranged reflection space 6a and one lower horizontally arranged reflection space 6b being indicated in FIG. 1. The display system also has a left vertically arranged reflection space and a right vertically oriented reflection space parallel thereto. In this case, each reflection space 6a, 6b has an inner side, an outer side, a front base side designed as the front side, and a rear base side designed as the rear side. Furthermore, for each reflection space 6a, 6b, it is provided that its inner side is covered and/or delimited by a wall designed as the outer edge of display panel 4, its outer side covered and/or delimited by a wall designed as an inner wall of the recess of component 2, its rear side covered and/or delimited by a mirror module designed as a full mirror 8a, 8b, and its front side covered and/or delimited by a mirror module designed as a half mirror 10a, 10b. The outer edge, the inner wall of the recess of component 2, and the two mirror modules enclose each reflection space 6a, 6b. Furthermore, light-emitting diodes as light sources 12 are arranged in and/or on the inner wall of component 2 along a strip and/or a line. A surface of full mirror 8a, 8b on the rear side of reflection space 6a, 6b, which faces reflection space 6a, 6b, is fully mirrored and/or 100% light-reflecting. In contrast, a surface of half mirror 10a, 10b on the front side of reflection space 6a, 6b, which faces reflection space 6a, 6b, is only partially mirrored, here semi-mirrored and/or 50% reflective for light and also 50% transmissive for light.

When carrying out the first embodiment of the method according to the disclosure for operating the first embodiment of the display system, light from light sources 12 is emitted into respective reflection space 6a, 6b, wherein the light is mutually and/or alternately reflected back and forth by the two mirror modules and/or between the two mirror modules in respective reflection space 6a, 6b, providing an infinity mirror and/or pinhole mirror effect. In this case, reflections of the light become visible to an observer 16 in the interior through the at least one partially mirrored mirror module or half mirror 10a, 10b arranged on the front side, which is partially transparent to light from reflection space 6a, 6b, here 50% transparent or semi-transparent, wherein reflections of the light from a fully mirrored mirror module designed as a full mirror 8a, 8b are also visible through half mirror 10a, 10b. In this case, an optical depth effect visible to observer 16 is created for display panel 4 or for a display content displayed therewith between reflection spaces 6a, 6b.

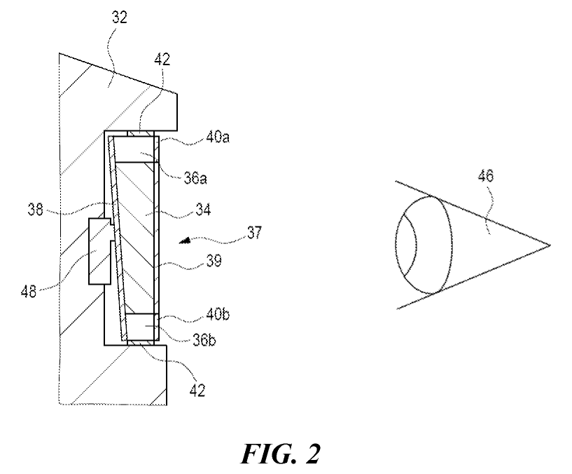

The second embodiment of the display system according to the disclosure, shown schematically in a sectional view in FIG. 2, is also arranged in a recess of a component 32, here a cockpit structure, in an interior of a vehicle.

The display system has a central display panel 34, which is framed and/or bordered here by four reflection spaces 36a, 36b, with only one upper horizontally arranged reflection space 36a and one lower horizontally arranged reflection space 36b being indicated in FIG. 2. The display system also has a left vertically arranged reflection space and a right vertically oriented reflection space parallel thereto, wherein here too each reflection space 36a, 36b has an inner side, an outer side, a front side, and a rear side. Its inner side is covered and/or delimited by an outer edge of display panel 34, its outer side covered and/or delimited by a wall formed by an inner wall of the recess of component 32, and its covered and/or delimited front side by a mirror module designed as a half-mirror 40a, 40b. In this case, all four mirror modules, designed as half-mirrors 40a, 40b and partially transparent to light, enclose a transparent window 39, which is largely fully transparent to light and covers a front side of central display panel 34, in a frame-shaped manner. The partially transparent mirror modules on reflection spaces 36a, 36b and window 39 on display panel 34 form a one-piece, continuous front cover 37 of the second embodiment of the display system. This cover 37 comprises here a layer transparent to light, for example a pane or a film, with those sections of an inner side of this layer that face a respective reflection space 36a, 36b and cover it being partially mirrored, here semi-mirrored and/or 50% reflective for light and also 50% transmissive for light.

As an alternative to the first embodiment of FIG. 1, rear sides of reflection spaces 36a, 36b and also a rear side of display panel 34 framed by them are covered by a single, one-piece, continuous full mirror 38 as a fully mirrored mirror module for all reflection spaces 36a, 36b. The display system comprises in this case a servo motor 48 arranged in the recess of component 32, connected to full mirror 38, and designed to tilt full mirror 38 horizontally, i.e., to the left or right, relative to reflection spaces 36a, 36b about a vertically oriented vertical axis of the vehicle and/or display panel 34, and/or to rotate it about the vertical axis. Servo motor 48 is further designed to tilt full mirror 38 vertically, i.e., downwards or upwards, relative to reflection spaces 36a, 36b, also about a horizontally oriented transverse axis of the vehicle and/or display panel 34, and/or to rotate it about the transverse axis, as is explicitly shown schematically in FIG. 2. In doing so, a distance of full mirror 38 from a respective half mirror 40a, 40b on a front side of a respective reflection space 36a, 36b, and furthermore a size and/or extent of respective reflection space 36a, 36b, is changed. In reflection space 36a, 36b in which front half mirror 40a, 40b is at a smaller distance from full mirror 38, the depth effect is less pronounced or reduced. Conversely, in reflection space 36a, 36b in which front half mirror 40a, 40b is at a greater distance from full mirror 38, the depth effect is greater or increased.

When carrying out the second embodiment of the method according to the disclosure for operating the second embodiment of the display system, light from light sources 42 is emitted into respective reflection space 36a, 36b and further partially reflected, here semi-reflected, in each reflection space 36a, 36b by half mirror 40a, 40b, providing an infinity mirror and/or pinhole mirror effect, and totally reflected by common full mirror 38. In this case, reflections from light sources 42 are visible to an observer 46 in the interior, creating a visible optical depth effect for observer 46.

By rotating full mirror 38 horizontally and/or vertically about the vertical axis and/or the horizontal transverse axis, an asymmetrical pinhole mirror effect and/or a depth effect can be created. In this case, a rotation of full mirror 38 is adapted to a sensor-detected movement - in this case, rotation - of the vehicle about its vertical axis and/or transverse axis during travel. Here, servo motor 48 moves rear full mirror 38 via a mechanism and/or a swashplate.

If, while negotiating a curve, the vehicle moves, here rotates, about its vertical axis in a respective direction of rotation, i.e., clockwise or counterclockwise, to the left or right, full mirror 38 is moved in the opposite direction about the vertical axis, here rotated in the opposite direction, to optically compensate for the respective movement for observer 46. If, while driving, the vehicle is alternatively or additionally accelerated positively or accelerated negatively or braked, it is moved, here rotated, about its transverse axis in a respective direction of rotation, i.e., clockwise or counterclockwise, upwards or downwards, wherein full mirror 38 is moved in the opposite direction, here rotated in the opposite direction, about the transverse axis, to optically compensate for the respective movement for observer 46. This can reduce motion sickness for observer 46 of display panel 34.

German patent application no. 102024137174.9, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A display system for a vehicle, comprising:
a display panel with four outer edges and at least two mirror modules, wherein a respective reflection space is arranged on each of at least two mutually parallel outer edges of the display panel, wherein front sides as front base sides of the reflection spaces are covered by at least one front mirror module, and rear sides as rear base sides of the reflection spaces are covered by at least one rear mirror module, wherein an inner side of each reflection space is delimited by a wall designed as an outer edge of the display panel, wherein an outer side of each reflection space is delimited by a further wall, wherein light sources are arranged on at least one of the walls of each reflection space, wherein the light sources are designed to emit light into the respective reflection space, wherein the mirror modules are designed to reflect the light in the respective reflection space, and wherein reflections of the light are visible through the at least one mirror module arranged on the front sides and are designed to create an optical depth effect for the display panel.

2. The display system according to claim 1, wherein a respective reflection space is arranged on each of horizontal outer edges and/or on each of vertical outer edges of the display panel.

3. The display system according to claim 1, wherein the at least one front mirror module is designed as a partial mirror, and the at least one rear mirror module is designed as a full mirror.

4. The display system according to claim 1, wherein each of at least one base side of each reflection space is covered by a mirror module, and/or wherein rear sides of all reflection spaces and a rear side of the display panel are covered by a common mirror module.

5. The display system according to claim 1, which has at least one servo motor which is designed to rotate the at least one rear mirror module relative to a display surface of the display panel.

6. The display system according to claim 1, wherein the light sources are arranged on the wall covering the inner side and/or the further wall delimiting the outer side of a respective reflection space.

7. A method for operating a display system for a vehicle, wherein the display system has a display panel with four outer edges and at least two mirror modules, wherein a respective reflection space is arranged on each of at least two mutually parallel outer edges of the display panel, wherein front sides of the two parallel reflection spaces are covered by at least one front mirror module, and rear sides of the two parallel reflection spaces are covered by at least one rear mirror module, wherein an inner side of each reflection space is delimited by a wall designed as an outer edge of the display panel, wherein an outer side of each reflection space is delimited by a further wall, wherein light sources are arranged on at least one of the two walls of each reflection space, the method comprising:
emitting light via the light sources into the respective reflection space, wherein the light is reflected by the two mirror modules in the respective reflection space, wherein reflections of the light are visible through the at least one mirror module arranged on the front sides, and wherein an optical depth effect is created for the display panel.

8. The method according to claim 7 for which a vertical axis, a transverse axis and a longitudinal axis are defined as spatial axes for the vehicle, the method further comprising:
detecting a rotation of the vehicle about at least one spatial axis by sensors; and
rotating the at least one rear mirror module opposite to a direction of the sensor-detected rotation of the vehicle relative to a display surface of the display panel.
